(19) United States
(12) Patent Application Publication
(10) Pub. No.: US 2025/0354634 A1
(43) Pub. Date: Nov. 20, 2025

(54) Buoyant Stretchable Hose Assembly and Mooring System

(71) Applicant: Woods Hole Oceanographic Institution, Woods Hole, MA (US)

(72) Inventor: Donald M. PETERS, Falmouth, MA (US)

(21) Appl. No.: 19/209,353

(22) Filed: May 15, 2025

Related U.S. Application Data
(60) Provisional application No. 63/647,791, filed on May 15, 2024.

(51) Int. Cl. F16L 11/133

(52) U.S. Cl. CPC F16L 11/133

(57) ABSTRACT

A buoyant stretchable hose assembly, and mooring systems utilizing same, adapted to be filled with a gas to change its buoyancy in water to create an upward curvature under calm conditions while providing sufficient scope during dynamic conditions to effectively moor a surface buoy or ship while minimizing damage to benthic communities.

### CROSS-REFERENCE TO RELATED APPLICATION

This application claims priority to U.S. Provisional Application No. 63/647,791 filed on 15 May 2024. The entire contents of the above-mentioned application, including the Appendix, are incorporated herein by reference as if set forth herein in entirety.

### FIELD OF THE INVENTION

This invention relates to hoses and mooring lines capable of cyclic stretching, and more particularly to mooring systems for dynamic environments which minimize damage to benthic communities.

### BACKGROUND OF THE INVENTION

Moorings, especially for surface buoys, exposed to waves from large bodies of water need to allow significant vertical and horizontal motions of the surface buoy, since the buoys are designed with sufficient buoyancy to follow the contours of the waves generated over large fetches such as ocean waves which can be 30 feet or higher in storms depending on location. The wave-generated motions are known as heave, surge and sway for vertical, horizontal and transverse motions, respectively. Mooring must also withstand horizontal drag loading on the mooring and buoy or ship, induced by ocean currents.

The term “scope” refers to a ratio of the effective length of a mooring line, also known as a mooring riser or an anchor rode, to the depth of water measured from the anchoring point on the seabed to the point of attachment on the buoy or other object to be moored.

Buoys have been utilized to suspend a wire along which a water profiler travels to measure characteristics through a water column. Wire-following profilers follow a taut wire. Most of these are based upon a subsurface mooring, where the wire tension is maintained by a subsurface buoy. These moorings are relatively static.

Wave-powered wire-following profilers are relatively new, and use the motion of a surface buoy to energize their profiling mechanism. These profilers require the wire to move cyclically in the vertical direction, and require a depressor weight to maintain tension in the wire. For these, the mooring needs to be slack or otherwise compliant below the depressor.

One challenge is to enable a substantial portion of the profiler wire to be generally vertical and free to move vertically with the surface buoy in order to be usable by the profiler while providing sufficient scope and compliance for the mooring between the surface buoy and an anchor on the seafloor.

Some existing mooring designs have an unstretched scope of 1.0 and employ 15-30 m of stretch hose. For constructions configured to have hose stretch of 100% to achieve extendable scope, these moorings can assume a fully stretched scope of 1.5 (50% elongation) to 2.0 (100% elongation). Existing buoys for this size mooring include the “Whale” buoy and the Ocean Observatories Initiative Profiler buoy. These buoys have a mooring attachment point at about 1.5 m depth, where either the stretch hose is directly terminated, or else a two-meter EM (electro-mechanical) chain is employed. Pressure within the stretch hoses relative to the surrounding water can be equalized or otherwise regulated by “open” systems which admit ambient water to fill the hoses after deployment at a selected site or by “closed” systems which are typically filled pre-deployment with fresh water containing antifreeze fluid to avoid ice crystal formation in cold weather aboard deployment vessels prior to deployment.

However, there are problems with the existing designs. In a 30 m water depth, for example, in order to profile the upper 80% of the water column, the profiler wire needs to run from the surface to a depth of 24 meters, leaving only 6 meters between the bottom of the wire and the seafloor. Since compliance in a wave-powered profiler mooring can only be located below the depressor weight (to keep the profiler wire taut and vertical while free to heave with the surface buoy), an existing 15 m “Whale” stretch hose from anchor to bottom of profiler wire would drag on the bottom, which would be unacceptable due to the resulting potential for mooring wear, entanglement, and environmental disturbance of sessile organisms on the seafloor.

Aspects of mitigating wave actions on moorings have been addressed to some extent as described by Paul and Peters in U.S. Pat. No. 8,279,714 and by Peters in U.S. Pat. No. 9,874,298, for example. Many of the current moorings use chains and/or ropes which provide the extra scope length for the mooring to conform to the wave action; undesirably, these chain segments drag along the seafloor creating a circle of destruction to the nearby ecosystem with benthic communities including sessile organisms that cannot avoid moving mooring components. Moorings typically have to be permitted, and environmental impact must be described or disclosed as part of this process. Even the one-meter diameter footprint of a deadweight anchor can be an issue, let alone a 10 or 20 m chain drag circle. Costly fines can be incurred for violations of such permits.

Accordingly, there is a need for a system for reliably and continuously maintains the mooring integrity and the water bottom ecosystem independently of the prevailing sea state.

### SUMMARY OF THE INVENTION

An object of the present invention is to provide a compliant mooring system which does not damage sessile organisms or other aspects of benthic communities in the vicinity of an anchor for the mooring system.

Another object of the present invention is to provide a buoyant hose assembly, and a mooring system utilizing same, which accomplishes scope compliance for the mooring system while protecting the seafloor around the anchor.

Yet another object of the present invention is to provide a compliant mooring system without requiring external floats or other buoyancy elements.

This invention features a buoyant stretchable hose assembly configured to be deployed in water and including a stretchable hose body defining a hollow interior extending between a first end and a second end. The hose assembly has a first termination assembly including a first male body insertable into the first end of the hose body and including a first termination cap, and a second termination assembly including a second male body insertable into the second end of the hose body and including a second termination cap. At least one of the first termination assembly and the second termination assembly includes at least one fill valve configured to accept a gas at greater than one atmosphere of pressure to pressurize the hose body. The pressurized hose body is positively buoyant at a selected water depth of at least twenty feet and is configured to withstand cyclic stretching as a component of a mooring line.

In some embodiments, at least one of the first male body and the second male body are hollow, and each termination cap associated with its respective hollow male body is removably secured to that male body and forms a gas-tight seal with that male body. In certain embodiments, the hose assembly further includes a first jointed connector attached to the first termination assembly and a second jointed connector attached to the second termination assembly, wherein each jointed connector articulates with more than one degree of freedom and enables at least twenty degrees of deflection and, in other embodiments, at least twenty-five degrees of deflection, more preferably at least thirty degrees of deflection.

In a number of embodiments, a first jointed connector is attached to the first termination assembly and a second jointed connector is attached to the second termination assembly, wherein at least one jointed connector includes at least two universal joints linked together to enable at least thirty degrees of deflection and, preferably, greater than forty-five degrees deflection for the assembly. In certain embodiments with multiple universal joints, each universal joint provides at least twenty-five degrees of deflection, such as approximately thirty degrees of deflection per universal joint to enable assemblies with two universal joints to have sixty degrees of deflection, three universal joints to provide ninety degrees of deflection, and so forth in an additive manner according to the present invention. In certain embodiments, the universal joints enable free or low-resistance bending in any direction within the jointed connector while protecting a central conduit or sleeve from various forces including compression and stretching.

This invention may also be expressed as a buoyant stretchable hose system which includes a stretchable hose body having a first end and a second end, and a plurality of layers formed around an inner liner layer defining a hollow center core and at least one strength member layer comprising helically-wrapped reinforcing fiber cords. At least some of the plurality of layers comprises an elastomeric material adapted to provide stretching of the hose to a stretched length of at least 150 percent of an unstretched length of the hose. The hollow center core is adapted to receive and hold a gas at greater than atmospheric pressure to augment the buoyancy of the hose in water.

In certain embodiments of the hose system, at least one end of the hose body includes a termination assembly having a valve as the inlet for inflating the hollow core of the buoyant stretch hose to greater than one atmosphere of pressure. In some embodiments, the hose system further includes at least one modular universal-joint-based flexible interface attached at an end of the buoyant stretch hose and adapted to enable bending up to a selected amount of deflection while limiting bend strain in the buoyant stretch hose.

In some embodiments, the strength member layer includes at least one stretch limiter layer at an end of the buoyant stretch hose and at least one reinforcement layer, such as stretch limiters and reinforcement layers disclosed in U.S. Pat. No. 9,874,298 by Peters, the present inventor. In a number of embodiments, the hose system further includes at least one conductor cable capable of transmitting electromagnetic radiation, each conductor cable comprising a conductive cross-sectional area capable of high-throughput of at least one of data, power, and communication and helically wrapped in a corresponding cable layer, within at least one cable layer located between the plurality of layers. In certain embodiments, the hose has been processed by heat-curing during manufacture to increase its tensile strength.

This invention also features a mooring system having a buoyant stretchable hose assembly including a stretchable hose body defining a hollow interior extending between a first end and a second end, a first termination assembly including a first male body insertable into the first end of the hose body and including a first termination cap, and a second termination assembly including a second male body insertable into the second end of the hose body and including a second termination cap. At least one of the first termination assembly and the second termination assembly includes at least one fill valve configured to accept a gas at greater than one atmosphere of pressure to pressurize the hose body, and the pressurized hose body is positively buoyant at a selected water depth of at least twenty feet. The mooring system further includes a first jointed connector attached to the first termination assembly and a second jointed connector attached to the second termination assembly, wherein each jointed connector enables at least thirty degrees of deflection.

In a number of embodiments, the hose assembly is adapted to be filled with a gas to change its buoyancy in water to create an upward curvature under calm conditions while providing sufficient scope during dynamic conditions to effectively moor a surface buoy or ship while minimizing damage to benthic communities. In certain embodiments, at least one of the first male body and the second male body are hollow, and each termination cap associated with its respective hollow male body is removably secured to that male body and forms a gas-tight seal with that male body. In some embodiments, at least one termination caps provide a splice cavity and may have a second endcap to facilitate integration of EMR conductor connections, either bulkhead or pigtail type, depending on intended use.

In one embodiment, the first jointed connector is attached, directly or via a weight such as a depressor, to a cable extending toward a surface buoy, and the second jointed connector is attachable to an anchor deployable on a seafloor. A at least one jointed connector includes at least two universal joints linked together to enable greater than forty-five degrees of deflection.

### BRIEF DESCRIPTION OF THE DRAWINGS

To enable a better understanding of the present invention, and to show how the same may be carried into effect, certain embodiments of the invention are explained in more detail with reference to the drawings, by way of example only, in which:

FIG. 1 is a schematic perspective view of one embodiment of a riser assembly of a mooring system according to the present invention wherein the lower segment is a buoyant stretchable hose assembly according to the present invention filled with a gas to provide buoyancy while maintaining the necessary scope of the system to readily comply with wave action while protecting benthic communities;

FIG. 2 is an enlarged side view of portion “A” in FIG. 1 showing an upper cable terminator of a vertically-oriented water profiler cable that interfaces with a surface buoy (not shown);

FIG. 3 is an enlarged side view of portion “B” in FIG. 1 showing a depressor secured to a lower cable terminator of the vertical cable and a universal joint assembly as a first jointed connector enabling more than ninety degrees of deflection for the buoyant stretchable hose;

FIG. 4 is an enlarged side view of portion “C” in FIG. 1 which attaches to an anchor (not shown);

FIGS. 5A-5F are various views of one embodiment of a buoyant stretch hose termination assembly with an end view of a flange of a termination cap (FIG. 5A), a first cross-sectional side view (SECTION A-A, FIG. 5B) with a partial enlarged view (DETAIL D, FIG. 5C), a perspective view (FIG. 5D), and a second cross-sectional side view showing a valve (SECTION B-B, FIG. 5E) with partial enlarged view (DETAIL C, FIG. 5F);

FIG. 6A is a side view of a modular universal joint assembly enabling 180 degrees of deflection similar to that of FIG. 3;

FIG. 6B is an end view of the left-hand flange of FIG. 6A looking at and through the entire joint assembly, which has a clear opening along the entire central axis, through which the EMR conductors run within a conductor sleeve, and which can deflect in bending without changing in overall length;

FIG. 7 provides perspective views of a series of modular universal joint assemblies have deflection capabilities of 30, 60, 90 and 120 degrees, respectively, wherein the 30-degree assembly is a variant of a known single u-joint design, whereas the multiple linked u-joint segments of greater than 45-degree deflection are embodiments of the present invention;

FIG. 8 is a perspective view of another modular universal joint assembly similar to those of FIGS. 3 and 6A with a conductor sleeve and EM conductor passing therethrough;

FIGS. 9A-9B are side views of a conductor sleeve unit, with FIG. 9B being an enlarged cross-sectional view along SECTION A-A of FIG. 9A; and

FIGS. 10A-10C depict a 60-degree u-joint assembly according to the present invention, shown as a side elevation view in FIG. 10A, in cross-sectional view in FIG. 10B along SECTION A-A of FIG. 10A, and in perspective view in FIG. 10C.

### DETAILED DESCRIPTION OF THE PRESENTLY PREFERRED EMBODIMENTS

The systems described herein relate to a buoyant hose assembly which provides oceanographic surface buoy and ship mooring systems with an extendable scope while not disrupting the water bottom ecosystem at most sea state and weather conditions. In particular, the assemblies and systems described herein provide mooring systems that can support one or more instruments connected to a surface mooring located offshore in shallow- and deep-water positions. Specifically, this novel system is designed to meet ocean regulations that preclude a mooring from destroying the ecosystem on the water bottom directly below and within a circumference defined by the scope of the mooring system.

As will be more fully described below, the present mooring system includes an extendable, stretching tether hose that accommodates a sufficient scope, also referred to as “high scope”, in overall mooring length to reliably secure a surface buoy even when the buoy moves in response to wave and weather. Specifically, the system comprises a stretchable hose with an inner diameter that is filled with a gas (e.g., air) to provide internal buoyancy, and termination assemblies at each end including at least one valve as the inlet for inflating the buoyant stretch hose. Preferably, one or more modular universal-joint-based flexible interfaces serve as jointed connectors engaged at the ends of the hose via the termination assemblies.

When used in one type of an instrument-based mooring system, a wire cable capable of mounting an oceanographic instrument (i.e., a water column profiler) is engaged at one end of the stretchable buoyant hose along with a weighted depressor to hold the cable taut in a vertical orientation. The amount of buoyancy required is relative to the outside diameter and mass of the stretchable hose and thus is an essential consideration of selecting a sufficiently large inner diameter to provide positive buoyancy at a selected deployment depth. The system may also include electro-mechanical (“EM”) capabilities by including one or more electromagnetic conductors capable of both transmitting electromagnetic radiation (“EMR”) and providing one or more mechanical functions. The term “EM” is utilized by the mooring community, and utilized herein, as shorthand for Electro-Mechanical. It refers to the function of a cable or other element and its terminations, or to an entire mooring. An EM cable, also referred to herein as an EM conductor, has strength members (mechanical) as well as EMR conductors (typically electrical or optical). Similarly, an EM termination functions as the mechanical interface between the cable strength member and other mooring elements, as well as the electrical interface between cable conductors and other electrical mooring elements. A mooring that provides an electrical connection to instruments on the seafloor is referred to as an EM mooring. If a mooring also incorporates optical fibers, it is called an EOM mooring.

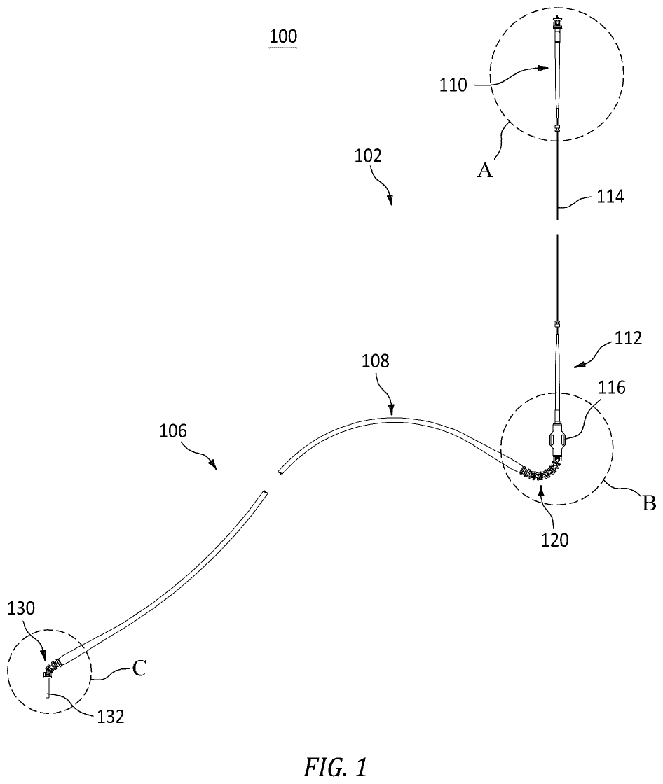

Mooring system 100, FIG. 1, includes a riser assembly 102 having a water profiler cable assembly 104 with profiler wire 114 bounded by upper and lower cable terminators 110, 112 and a buoyant stretchable hose assembly 106 with gas-filled hose 108. In one construction as illustrated and described herein carrying EM conductors, riser assembly 102 qualifies as a fully EM riser, surface to seafloor. Upper cable terminator 110 is connectable to a surface buoy (not shown), and lower cable terminator 112 carries a weighted depressor 116 that is connected to hose assembly 106 via a first modular universal-joint based flexible interface as a first jointed connector 120. A second jointed connector 130 is attached to an element 132 which attaches to an anchor (not show) which rests on or into the seafloor. The stretch hose assembly 106 has a length sufficiently long to provide the necessary scope and compliance for storm conditions, but sufficiently buoyant so that the hose assembly 106 will float without a downward curvature and, preferably, with an upward curvature as illustrated in FIG. 1 under calm conditions.

Mooring system 100, FIG. 1, enables a wave-powered wire-following profiler instrument (not shown) to sample along the depth of the water column in a straight line without causing undue damage to the water bottom. Specifically, this design intends to keep the profiler wire as vertical as possible and minimize any off-axis motions while also preventing any destructive bending at the various terminations between components of the mooring. Upper cable terminator 110 is integrated near to the surface waterline above the profiler wire 114 with no room for a typical EM chain. Below the profiler wire 114 and attached at lower cable terminator 112, a depressor weight 116 maintains tension in the wire 114. The depressor 116 is made to be as heavy as needed to keep the wire 116 taut and to minimize entrained or added heave on the wire 116 which is determined through modeling of the water conditions.

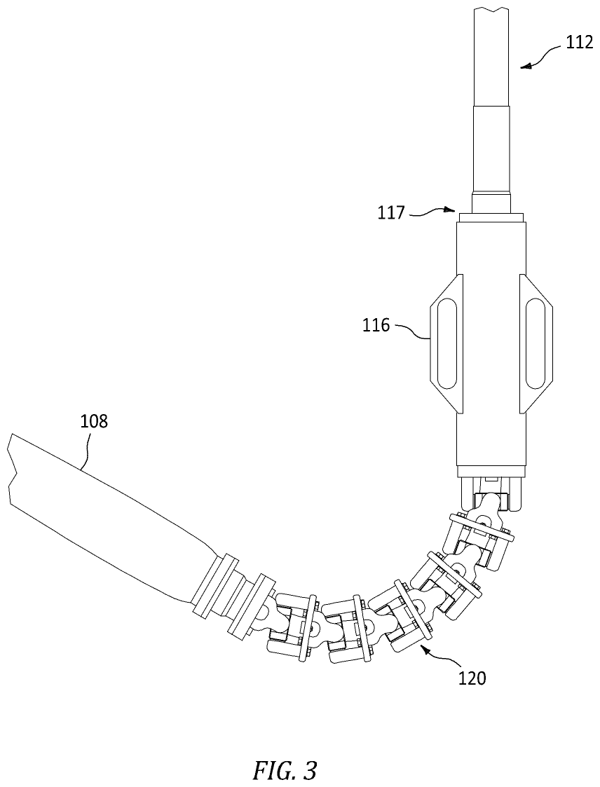

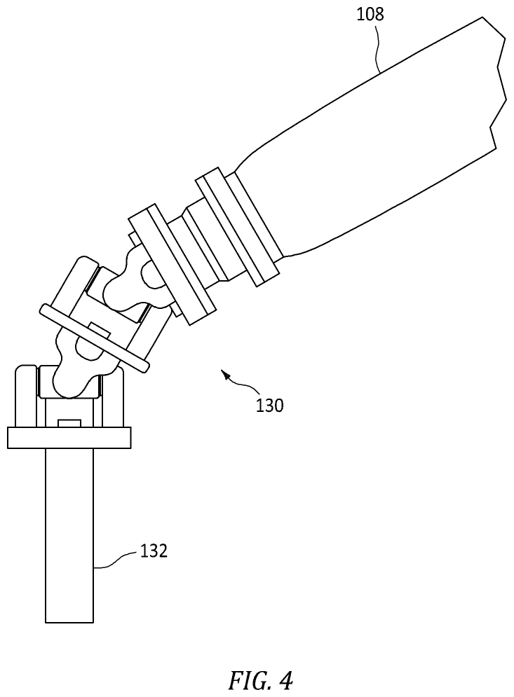

As described in U.S. Pat. No. 9,874,298 by Peters (the Peters '298 Patent) entitled “Multi-Layered Stretchable Hose” for negatively-buoyant hoses, a stretchable hose in some constructions is comprised of a series of layered materials, each layer optimized to provide the necessary strength under load, elasticity, and torque balance over the stretch range. Such hoses are often comprised of rubber, nylon tire cord for reinforcement, EMR conductors, and Aramid tire cord for fish-bite and cut protection. One or more layers of the hose are helically wrapped about a central axis of a core for specified diameter, pitch, and ribbon width. The completed wrapped hose is then vulcanized in a steam autoclave. See, e.g., FIGS. 3-6B of U.S. Pat. No. 8,279,714 by Paul and Peters (the Paul and Peters '714 Patent) and FIGS. 4-8C of the Peters '298 Patent, and descriptions referring thereto, for multiple layers of strength members and EMR conductors helically wrapped in “stretch-neutral” configurations. The entire contents of each of the Paul and Peters '714 Patent and the Peters '298 Patent are incorporated herein by reference as if set forth herein in entirety.

While the hose can be adjusted to increase or decrease the amount of elongation or “stretchiness”, the design intends to equalize the load among the reinforcement layers while still optimizing the path for the non-load bearing layers including the helically wrapped EMR conductors and Aramid layers within the hose. Adding to the complexity of designing a functional stretch hose relates to the mechanical interactions which occur at high strains and that are not characterized or entirely understood. Such interactions include adequately understanding the shear forces between layers and the compressive forces in cord layers. As in the current invention, analyzing these forces with respect to a section of hose with and internal air volume is additionally complicated.

The stretch hose is made buoyant according to the present invention by filling the center of the hose with a gas, which in most circumstances would be air. In design, the gas (e.g., air) needs to be under enough initial pressure in order to exceed atmospheric pressure (approximately 15 psi) and, preferably, matching or exceeding the ambient hydrostatic pressure at the selected deployed depth. Filling an existing design stretch hose, as one described in the Peters '298 Patent with its 1″ internal diameter (ID) hose with compressed air makes it slightly lighter in water, but not positively buoyant. Therefore, the present buoyant stretch hose adjusts the hose center to a larger ID such as 2″ ID. In other words, one aspect of the present invention results from the realization that the hollow core of existing stretch hoses can be enlarged and filled with a gas under pressure to serve as a buoyancy chamber to provide internal flotation. In one specific embodiment, the stretchable hose segment is prefilled with a gas such as air to an internal pressure between 60 to 90 psi.

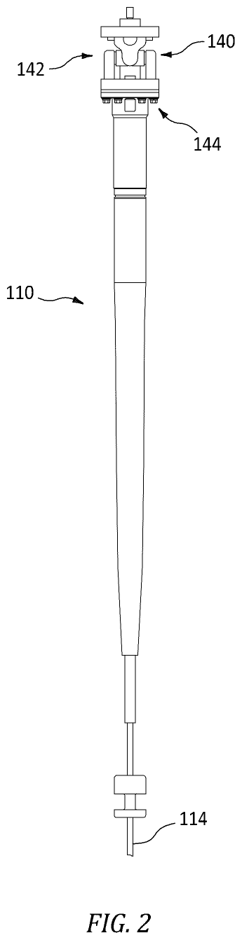

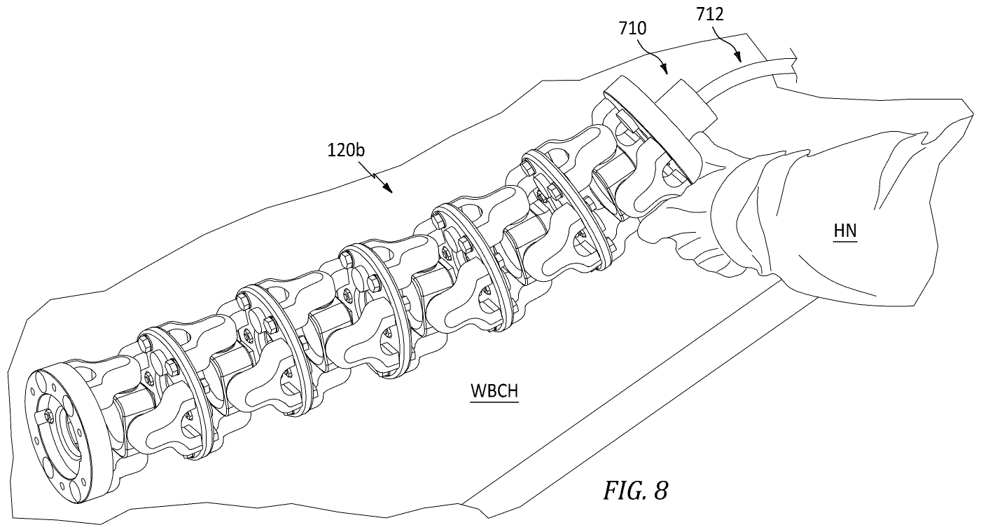

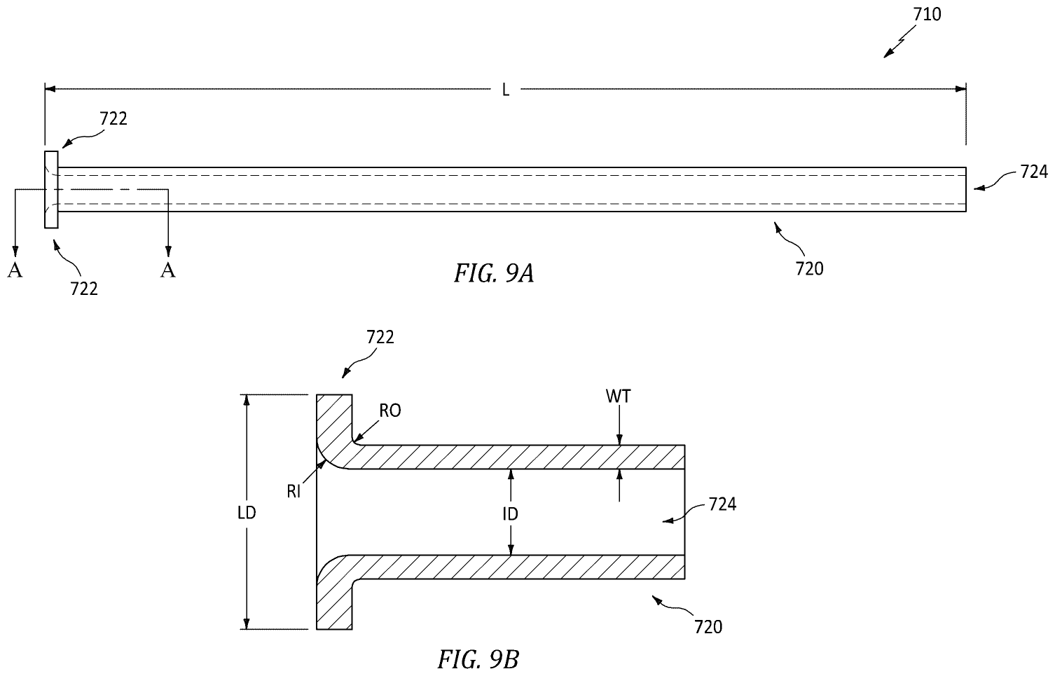

The upper portion of riser assembly 102 is shown in a closer detailed perspective in FIG. 2 for portion “A” shown in FIG. 1 depicting the upper cable terminator 110 with a jointed connector 140 formed of universal joints enabling thirty degrees of deflection with a surface buoy to provide bend strain relief with wire 114 at this region. In certain constructions, additional components include a joint conductor sleeve 142 within the connector 140 and a reinforced neoprene flange gasket 144. See, e.g., conductor sleeve 710, FIGS. 8-9B.

One aspect of the present invention is the modular universal-joint-based flexible interface which can add whatever amount of deflection is desired. Stretch hoses are built with a significant bend strain relief at the terminations, described in more detail below and in the Peters '298 Patent as stretch limiters to form a gradual transition from the stretchiness of the main hose body to non-stretchy terminations, making the hoses stiff in bending at the ends. In slack conditions, the buoyant hose preferably will float with an upward curvature, meaning the ends are pointing downward relative to the profiler wire depressor. Since the profiler wire is also pointing downward, a directional discontinuity will result where the downward-pointing hose end connects with the downward-pointing profiler wire. A flexible mooring interface is therefore utilized according to the present invention to enable the directional discontinuity and decouple the stiff hose from the depressor weight at the necessarily straight bottom of the profiler wire.

The currently preferred modular flexible interface is based on a universal joint design having at least two universal joint segments linked together. In some constructions, each segment can freely deflect up to 30 degrees in any direction and defines a center opening or passage. Multiple segments can be chained (linked) together to provide free deflection of 30, 60, 90, 120 degrees, etc. In several embodiments, the hose-depressor interface employs six segments, for a total deflection range of up to 180 degrees; however, more or fewer of these segments may be included to reach a selected deflection angle for selected usages.

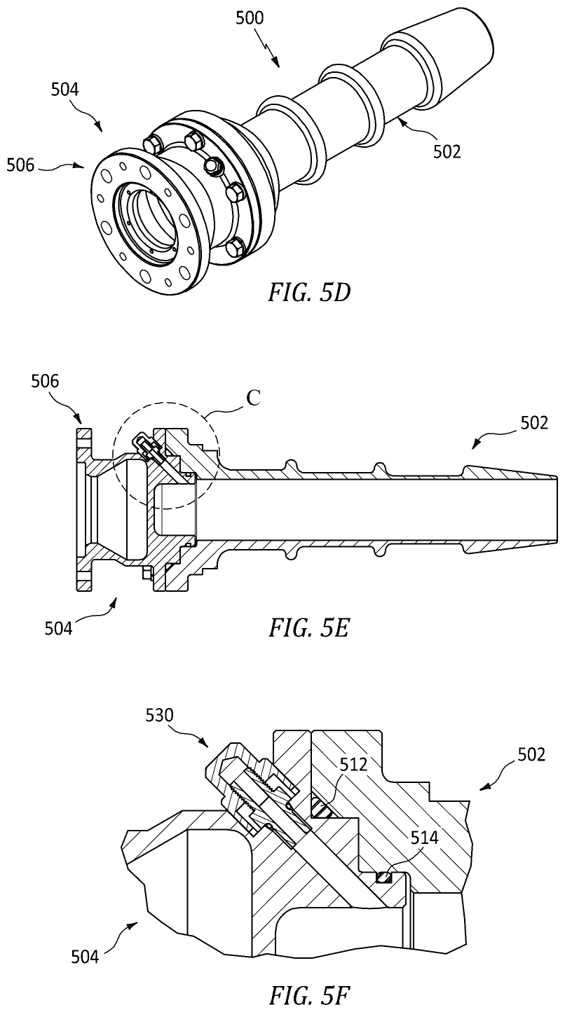

Since a currently preferred construction of the mooring carries a plurality of EMR conductors through to an anchor device on the seafloor, the flexible interface is designed to include a robust electrical pathway which bends but does not compress or stretch in length within the jointed connector, as illustrated in FIGS. 6A-8 and 10A-10C, for example. Each jointed connector assembly 120a or 120b (shown being held on a work-bench WBCH by a human HN for scale in FIG. 8) carries a joint conductor sleeve, such as sleeve 710, FIGS. 8-9B, running through a central axial opening 604 of base flange 602 and each of the six universal joints 606, 608, 610, 612, 614, and 616, FIG. 6A, through which the EMR conductors 712 are passed as shown in FIG. 8.

The universal joints, also referred to herein as u-joints, are analogous to vertebrae of a spine that enable free or low-resistance bending in any direction within a jointed connector while protecting a central spinal cord from various forces including compression and stretching. In other constructions without EMR conductor capability, two or more links of chain and/or shackles without central longitudinal (that is, axial) passages could serve as a “jointed connector” at the lower end of the stretchable hose assembly instead of multiple “stacked” universal joints. Such “loose” hardware would not be appropriate for a surface mooring where loading is dynamic and includes periodic slack conditions. Shackles, links, and chain will be subject to chafing and wear, creating potential failure points. Instead, bolted flange mechanical interfaces are utilized in surface moorings to prevent free motion, preferably utilizing u-joints. In subsurface moorings where the load is static, it is acceptable to use shackles, links, and chain.

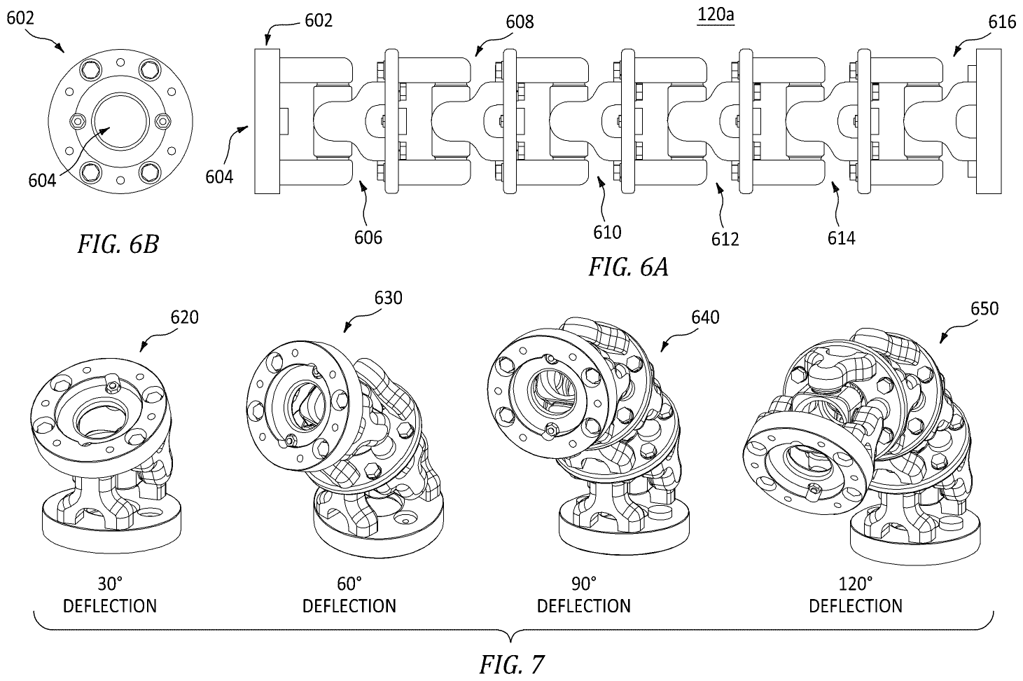

FIG. 3 is a closer detailed perspective of portion “B” shown in FIG. 1 depicting lower cable terminator 112 connected to depressor 116 with flange gasket 117 inserted therebetween. First jointed connector 120 contains a sufficient number of pivotable universal joint segments, linked in series, to enable deflection of at least 90 degrees, with configurations of increasing preference of at least 120, 150, and 180 degrees, relative to the lower cable terminator 112 of profiler cable assembly 104 when it is suspended vertically in water column. See joint assemblies 620, 630, 640 and 650, FIG. 7, which are configured to provide deflections of 30-, 60-, 90- and 120-degrees of deflection, respectively. In some constructions, each u-joint provides 30 degrees of deflection, in an additive manner. The 30-degree assembly 620 is a variant of a known single u-joint design, whereas the multiple u-joint segments of greater than 45 degrees of deflection, such as assemblies 630, 640 and 650, are embodiments of the present invention.

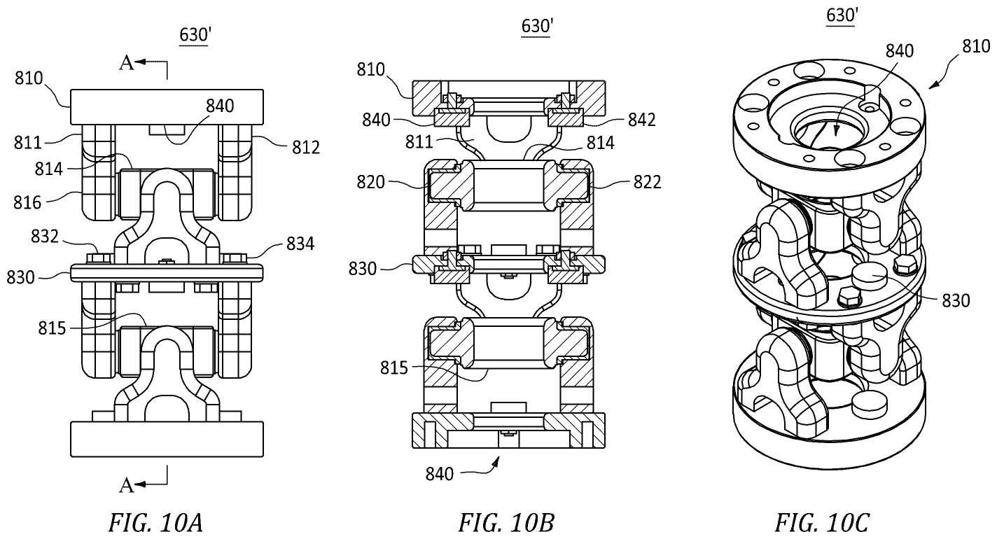

FIG. 4 is a closer detailed perspective of portion “C” shown in FIG. 1 depicting the components interfacing between the buoyant stretch hose 108 and the water bottom anchor (not shown) including the universal joint assembly of second jointed connector 130 and anchor connector 132. In one usage of the present mooring system, a MFN (Multi-Function Node) serves as an anchor and oceanographic instrument location that sits on the seafloor. Second jointed connector 130 preferably provides greater than 45 degrees of deflection, and preferably at least 60 degrees relative to anchor connector 132 and assembly 630′ described below in relation to FIGS. 10A-10C.

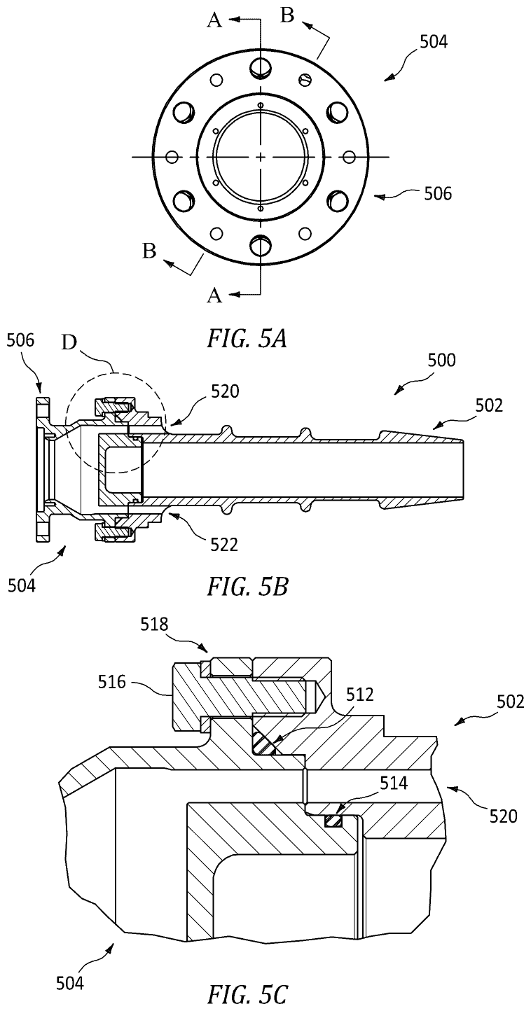

Various views of a termination assembly 500 are shown in FIGS. 5A-5F including a male body 502 insertable into an end of the hose body and a termination cap 504. FIGS. 5A-5C depict the buoyant stretch hose termination assembly 500 from perspective “A” in FIG. 5A. FIGS. 5B-5C show the male body 502 engaging with a termination cap 504 having a flange 506. Detail D, FIG. 5C, shows a close-up view of O-rings 512 and 514 providing a water-tight seal and a hex bolt 516 and lock washer 518 removably securing the termination cap 504 to the male body 502 in a gas-tight fashion. Passages 520 and 522 are defined within portions of body 502 and cap 504; each passage accepts one or more EMR conductors and can be potted after assembly. The termination caps preferably provide a splice cavity and may have a second endcap to facilitate integration of EMR conductor connections, either bulkhead or pigtail type, depending on intended use.

FIGS. 5E-5F depict the buoyant stretch hose termination assembly 500 from perspective “B” in FIG. 5A to provide another cross-sectional view of the male body 502 engaging with the termination cap 504. Detail C, FIG. 5F, shows a close-up view of the valve 530, such as a Schraeder-type valve having a valve cap and a valve stem, as the inlet for inflating the buoyant stretch hose.

FIGS. 9A-9B are side views of a polymeric modular conductor sleeve unit 720 of a conductor sleeve 710. In this construction, sleeve unit 720 is a polyurethane conduit segment defining a passage 724 and having an overall length L of approximately 40 inches, an internal diameter ID of approximately 1.25 inch, and a wall thickness WT of approximately 0.35 inch. A flared lip 722 has a lip diameter LD of approximately 3.4 inch, an inner radius RI and an outer radius RO. Sleeve units are engaged end-to-end to provide a selected overall length of conductor sleeve 710, with any excess length trimmed at the end opposite from lip 722.

FIGS. 10A-10C depict a 60-degree u-joint assembly 630′ according to the present invention having a base flange 810 with cheek arms 811 and 812 which pivotably engage two pintle projections of a spider element 814 having four pintles, spaced ninety degrees apart, such as pintles 820 and 822 shown in FIG. 10B. One or more bushings 816 can be utilized, preferably with a bushing surrounding each pintle where it engages a corresponding recess in the respective cheek arm. Similarly, a second u-joint has a spider element 815. An intermediate plate 830 is secured to adjoining cheek arms by hex bolts 832 and 834, each with a corresponding lock washer. Each component that is linked with other components has a central opening to define a central passage 840 through the entire joint assembly 630′, as best seen in FIGS. 10B-10C. Resilient bumpers such as elastomeric bumpers 840 and 842 have threaded shafts secured with hex nuts in one construction and establish limits of deflection for each u-joint. Free bending in one or more jointed connectors permits overall free bending in a mooring riser according to the present invention.

The system may also include an additional buoyancy device, also referred to as an inter-buoyancy element, that further prevents the mooring system from dragging on the water bottom in the case that the stretchable hose section loses air and full buoyancy. See, e.g., plastic floats 29 in FIG. 1B of U.S. Pat. No. 8,279,714 by Paul et al.

The term “portion” as utilized herein refers to a section or region of a component, without necessarily indicating any physical difference between two or more portions apart from location such as “upper portion” and “lower portion”.

Although specific features of the present invention are shown in some drawings and not in others, this is for convenience only, as each feature may be combined with any or all of the other features in accordance with the invention. While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they may be merely conceptual in nature.

It is the intention, therefore, to be limited only as indicated by the scope of the claims appended hereto. Other embodiments will occur to those skilled in the art after reviewing the present disclosure and are within the following claims.

What is claimed is:

1. A buoyant stretchable hose assembly configured to be deployed in water, comprising:
a stretchable hose body defining a hollow interior extending between a first end and a second end;
a first termination assembly including a first male body insertable into the first end of the hose body and including a first termination cap;
a second termination assembly including a second male body insertable into the second end of the hose body and including a second termination cap;
wherein at least one of the first termination assembly and the second termination assembly includes at least one fill valve configured to accept a gas at greater than one atmosphere of pressure to pressurize the hose body; and
wherein the pressurized hose body is positively buoyant at a selected water depth of at least twenty feet and is configured to withstand cyclic stretching as a component of a mooring line.

2. The hose assembly of claim 1 wherein at least one of the first male body and the second male body are hollow.

3. The hose assembly of claim 2 wherein each termination cap associated with its respective hollow male body is removably secured to that male body and forms a gas-tight seal with that male body.

4. The hose assembly of claim 1 further including a first jointed connector attached to the first termination assembly and a second jointed connector attached to the second termination assembly, wherein each jointed connector enables at least twenty degrees of deflection.

5. The hose assembly of claim 1 further including a first jointed connector attached to the first termination assembly and a second jointed connector attached to the second termination assembly, wherein at least one jointed connector includes at least two universal joints to enable at least thirty degrees of deflection.

6. The hose assembly of claim 5 wherein at least one of the jointed connectors enables greater than forty-five degrees of deflection.

7. The hose assembly of claim 5 wherein at least one of the jointed connectors enables at least ninety degrees of deflection.

8. A buoyant stretchable hose system, comprising:
a stretchable hose body having a first end and a second end, and including a plurality of layers formed around an inner liner layer defining a hollow center core and at least one strength member layer comprising helically-wrapped reinforcing fiber cords;
wherein at least some of the plurality of layers comprises an elastomeric material adapted to provide stretching of the hose to a stretched length of at least 150 percent of an unstretched length of the hose; and
wherein the hollow center core is adapted to receive and hold a gas at greater than atmospheric pressure to augment the buoyancy of the hose in water.

9. The hose system of claim 8 wherein at least one end of the hose body includes a termination assembly having a valve as the inlet for inflating the hollow core of the buoyant stretch hose to greater than one atmosphere of pressure.

10. The hose system of claim 8 further including at least one modular universal-joint-based flexible interface attached at an end of the buoyant stretch hose and adapted to enable bending up to a selected amount of deflection while limiting bend strain in the buoyant stretch hose.

11. The hose system of claim 8 wherein the strength member layer includes at least one stretch limiter layer at an end of the buoyant stretch hose and at least one reinforcement layer.

12. The hose system of claim 8 further including at least one conductor cable capable of transmitting electromagnetic radiation, each conductor cable comprising a conductive cross-sectional area capable of high-throughput of at least one of data, power, and communication and helically wrapped in a corresponding cable layer, within at least one cable layer located between the plurality of layers.

13. The hose system of claim 8 wherein the hose has been processed by heat-curing during manufacture to increase tensile strength of the hose.

14. A mooring system comprising:
a buoyant stretchable hose assembly including a stretchable hose body defining a hollow interior extending between a first end and a second end, a first termination assembly including a first male body insertable into the first end of the hose body and including a first termination cap, and a second termination assembly including a second male body insertable into the second end of the hose body and including a second termination cap;
wherein at least one of the first termination assembly and the second termination assembly includes at least one fill valve configured to accept a gas at greater than one atmosphere of pressure to pressurize the hose body, and the pressurized hose body is positively buoyant at a selected water depth of at least twenty feet; and
a first jointed connector attached to the first termination assembly and a second jointed connector attached to the second termination assembly, wherein each jointed connector enables at least thirty degrees of deflection.

15. The system of claim 14 wherein the hose assembly is adapted to be filled with a gas to change its buoyancy in water to create an upward curvature under calm conditions while providing sufficient scope during dynamic conditions to effectively moor a surface buoy or ship while minimizing damage to benthic communities.

16. The system of claim 14 wherein at least one of the first male body and the second male body are hollow.

17. The system of claim 16 wherein each termination cap associated with its respective hollow male body is removably secured to that male body and forms a gas-tight seal with that male body.

18. The system of claim 14 where the first jointed connector is attached to a cable extending toward a surface buoy.

19. The system of claim 14 wherein the second jointed connector is attachable to an anchor.

20. The system of claim 14 wherein at least one jointed connector includes at least two universal joints linked together to enable greater than forty-five degrees of deflection.
